(19) United States
(12) Patent Application Publication
(10) Pub. No.: US 2010/0293468 A1
(43) Pub. Date: Nov. 18, 2010

(54) AUDIO CONTROL BASED ON WINDOW SETTINGS

(75) Inventor: Jeroen Reinier THIJSSEN, Bara (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/464,295

(22) Filed: May 12, 2009

(51) Int. Cl. G06F 3/048; G06F 3/16

(52) U.S. Cl. 715/727; 715/800

(57) ABSTRACT

A method includes displaying a window associated with an application, providing audio content associated with the application, receiving a user input, determining whether the user input corresponds to a window manipulation of the window, where the window manipulation is other than a closing of the window, determining an audio setting that corresponds to a window setting associated with the window manipulation, when it is determined that the user input corresponds to the window manipulation, and outputting the audio content in correspondence to the audio setting.

### BACKGROUND

With the development of wireless devices, such as portable, handheld, and mobile devices, users may access and exchange information anywhere and anytime. Typically, these wireless devices offer users a variety of services and applications. For example, these wireless devices may provide users with telephone service, e-mail service, texting service, as well as provide other types of applications, such as, music and video applications, to permit users to listen and watch various types of multimedia. However, users may be hampered when interacting with audio content based on commonly-adopted design characteristics. For example, it is not uncommon for users to have to access a separate application (e.g., by clicking a speaker icon) to control and/or set audio parameters associated with audio content to which the users are listening.

### SUMMARY

According to one aspect, a method may include displaying, by the user device, a window associated with an application; providing, by the user device, audio content associated with the application; receiving, by the user device, a user input; determining, by the user device, whether the user input corresponds to a window manipulation of the window, where the window manipulation is other than a closing of the window; determining, by the user device, an audio setting that corresponds to a window setting associated with the window manipulation, when it is determined that the user input corresponds to the window manipulation; and outputting, by the user device, the audio content in correspondence to the audio setting.

Additionally, the method may include determining, by the user device, whether the application provides audio content.

Additionally, the outputting may include increasing, by the user device, a volume associated with the audio content, when the window manipulation corresponds to an increasing of a size of the window; and decreasing, by the user device, the volume associated with the audio content, when the window manipulation corresponds to a decreasing of a size of the window.

Additionally, the volume may correspond to a ratio between the size of the window and an overall size of a display of the user device.

Additionally, the outputting may include minimizing or muting, by the user device, a volume associated with the audio content, when the window manipulation corresponds to a minimizing of a size of the window; and maximizing, by the user device, a volume associated with the audio content, when the window manipulation corresponds to a maximizing of a size of the window.

Additionally, the outputting may include panning, by the user device, the audio content based on a position of the window on a display.

Additionally, the outputting may include outputting, by the user device, a stereo narrowing associated with the audio content when the window manipulation corresponds to a positioning of the window to a first position on a display; and outputting, by the user device, a stereo widening associated with the audio content when the window manipulation corresponds to a positioning of the window to a second position on the display, where the first position and the second position are different.

Additionally, the outputting may include adjusting, by the user device, a volume associated with the audio content when the window manipulation corresponds to a layering adjustment of the window with respect to another window.

According to another aspect, a user device may display a window associated with an application; receive a user input; determine whether the user input corresponds to a window manipulation of the window, where the window manipulation is other than a closing of the window; select an audio setting that corresponds to a window setting associated with the window manipulation, when it is determined that the user input corresponds to the window manipulation of the window; and output audio content associated with the application in correspondence to the audio setting that corresponds to the window setting.

Additionally, the user device may determine whether the application provides audio content.

Additionally, the user device may include a wireless telephone.

Additionally, when outputting, the user device may increase the volume associated with the audio content, when the window manipulation corresponds to an increase in a size of the window; and decrease the volume associated with the audio content, when the window manipulation corresponds to a decrease in a size of the window.

Additionally, when outputting, the user device may minimize or mute a volume associated with the audio content, when the window manipulation corresponds to a minimizing of a size of the window; and maximize a volume associated with the audio content, when the window manipulation corresponds to a maximizing of a size of the window.

Additionally, when outputting, the user device may pan the audio content in correspondence to a position of the window on a display.

Additionally, when determining whether the user input corresponds to the window manipulation, the user device may identify a position of the window on a display; when outputting, the user device may provide a stereo narrowing based on the position of the window on the display.

Additionally, when determining whether the user input corresponds to the window manipulation, the user device may identify a position of the window on a display; when outputting, the user device may provide a stereo widening based on the position of the window on the display.

Additionally, when determining whether the user input corresponds to the window manipulation, the user device may identify whether a layering of the window with respect to another window exists; identify whether the window manipulation corresponds to a re-layering of the window with respect to the other window; and when outputting, the user device may adjust a volume associated with the audio content of the window when it is determined that the window manipulation corresponds to the re-layering.

According to still another aspect, a computer-readable medium may include instructions executable by at least one processor. The computer-readable medium may store instructions for determining whether a user input corresponds to a window manipulation of a window associated with an application, where the window manipulation is other than a closing of the window; selecting an audio setting that corresponds to a window setting associated with the window manipulation, when it is determined that the user input corresponds to the window manipulation of the window; and outputting audio content associated with the application in correspondence to the audio setting that corresponds to the window manipulation.

Additionally, the computer-readable medium may reside on a portable device.

Additionally, the instructions for outputting may include adjusting one of a volume, a stereo effect, a panning, or a phantom imaging, of the audio content, in correspondence to the window manipulation.

### BRIEF DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIG. 1 is a diagram illustrating an overview of an exemplary embodiment described herein;

FIG. 2 is a diagram illustrating an exemplary user device in which the embodiments described herein may be implemented;

FIG. 3 is a diagram illustrating exemplary components of the user device depicted in FIG. 2;

FIG. 4 is a diagram illustrating exemplary functional components associated with a window manager depicted in FIG. 3;

FIG. 5 is a flow diagram illustrating an exemplary process for controlling audio settings based on window settings; and

FIGS. 6A and 6B are diagrams illustrating an exemplary scenario related to controlling audio settings based on window settings.

### DETAILED DESCRIPTION

The following detailed description refers to the accompanying drawings. The same reference numbers in different drawings may identify the same or similar elements. Also, the following description does not limit the invention.

The term “window,” as used herein, is intended to be broadly interpreted to include a visual portion of how an application is represented to a user. For example, the visual or graphical representation of an application and/or its interface may be represented in a window. The window may be of any size or shape.

The term “window settings,” as used herein, is intended to be broadly interpreted to include various settings associated with a window. For example, the window may include various settings to permit, for example, a resizing of the window, a minimizing of the window, a maximizing of the window, a layering of the window with respect to another window, and a positioning of the window anywhere on a display. These window settings may adjusted by a user.

### Overview

Embodiments described herein relate to audio control based on window settings. That is, audio settings associated with an application may be coupled to window settings (e.g., size and/or position of the window) associated with the application. For example, when a user increases (i.e., resizes) a size of the window, the volume may be increased. Conversely, when the user decreases the size of the window, the volume may be decreased. Additionally, when the window is minimized, the volume may be significantly decreased or muted. Conversely, when the window is maximized, the volume may be significantly increased. In one embodiment, the volume may be proportional to a total area of the window vis-a-vis a total area of a display associated with a user device. In another embodiment, the volume with respect to the size of the window may be a user-configurable parameter.

Additionally, the position of the window may correspond to a panning feature. For example, when the window is positioned to a right side of the display, the audio may be perceived by the user as panned to the right. Conversely, when the window is positioned to a left side of the display, the audio may be perceived by the user as panned to the left.

Additionally, the position of the window may correspond to a stereo effect. For example, when the window is positioned in an upper half of the display, the audio may be perceived by the user as a stereo narrowing. Conversely, when the window is positioned in a lower half of the display, the audio may be perceived by the user as a stereo widening.

Additionally, when multiple windows are displayed, the user may control the audio with respect to each window. For example, when one window covers a portion of another window, the volume associated with the top layer window may be increased and the volume associated with the bottom layer window may be decreased or muted.

In one embodiment, a window setting and corresponding audio setting may be global, regardless of the application. In another embodiment, a window setting and corresponding audio setting may be application-specific. For example, a window setting and corresponding audio setting associated with a telephone application may be different from the same window setting and corresponding audio setting associated with a browser application.

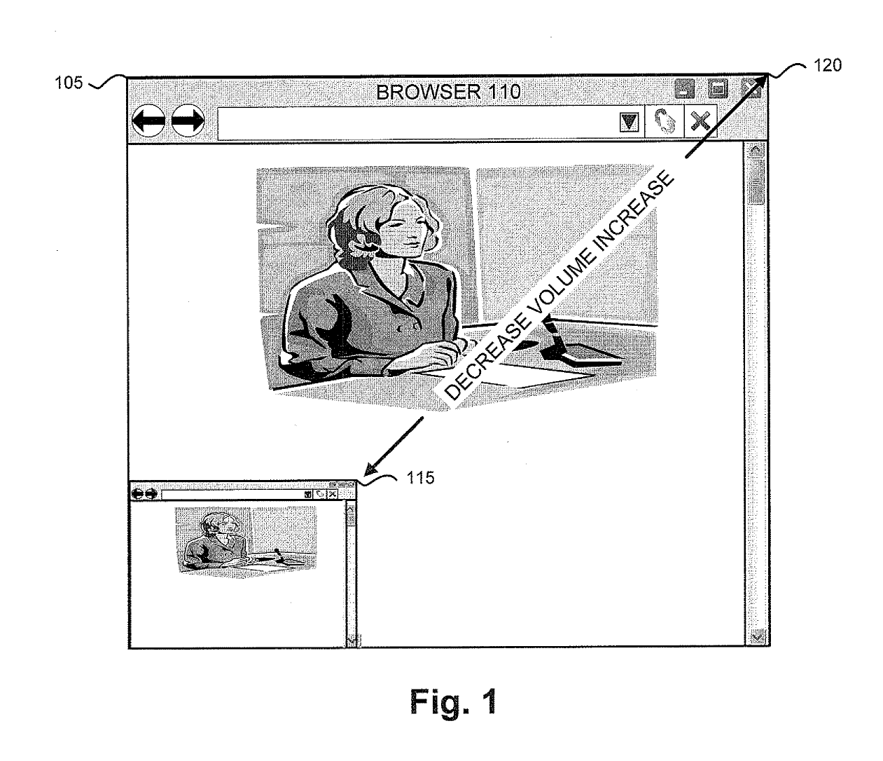

FIG. 1 is a diagram illustrating an overview of an exemplary embodiment described herein. As illustrated, an exemplary window 105 may be displayed to a user on a display associated with a user device. In an exemplary scenario, assume that the user is watching a video in a browser application 110. As illustrated, the user may resize window 105 to adjust the volume. For example, when the user decreases the size of window 105 to a size corresponding to window 115, the audio associated with the video may be decreased. Conversely, when the user increases the size of window 115 to a size corresponding to window 120, the audio associated with the video may be increased.

As a result of the foregoing, the user may control audio settings based on the manipulation of a window associated with an application. The exemplary embodiment has been broadly described with respect to FIG. 1. Accordingly, a detailed description and variations to this embodiment are provided below.

### Exemplary Device

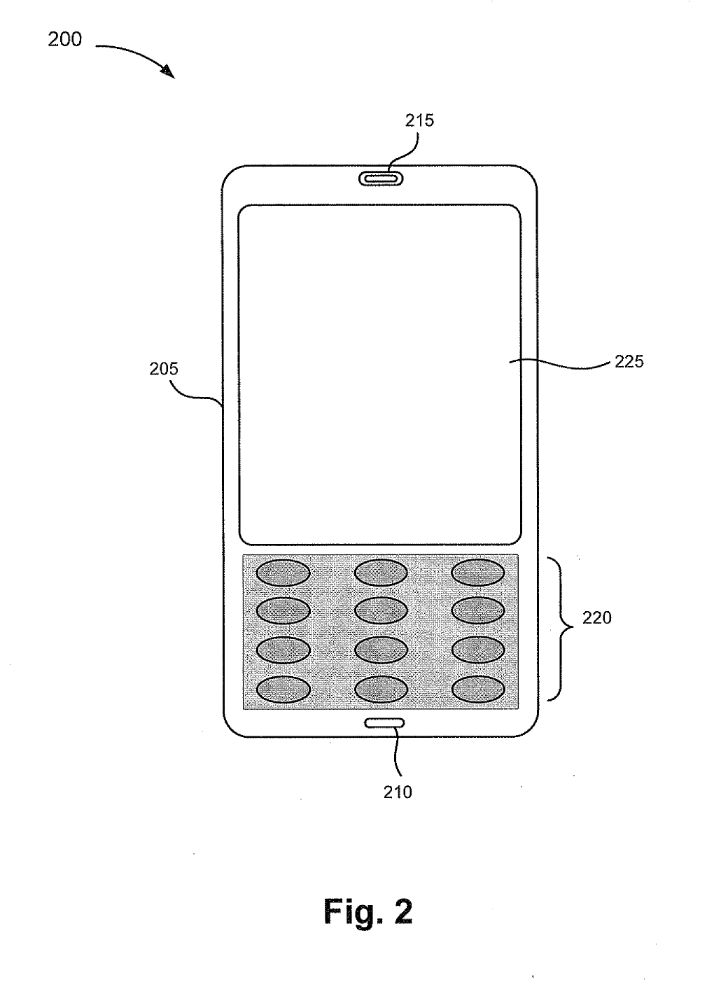

FIG. 2 is a diagram of an exemplary user device 200 in which the embodiments described herein may be implemented. The term “user device,” as used herein, is intended to be broadly interpreted to include a variety of devices. For example, user device 200 may include a portable device, a mobile device, a handheld device, or a stationary device, such as a wireless telephone (e.g., a smart phone or a cellular phone), a personal digital assistant (PDA), a pervasive computing device, a computer (e.g., a desktop computer, a laptop computer, a palmtop computer), a music playing device, a multimedia playing device, a television (e.g., with a set top box and/or remote control), a vehicle-based device, or some other type of user device. Additionally, user device 200 may, in some instances, include a combination of devices, such as a visual displaying device coupled to an audio producing device. For example, the visual displaying device may correspond to a portable, mobile, handheld, or stationary device, which is coupled to a stereo system or some other type of audio producing device.

As illustrated in FIG. 2, user device 200 may include a housing 205, a microphone 210, speakers 215, a keypad 220, and a display 225. In other embodiments, user device 200 may include fewer, additional, and/or different components, or a different arrangement of components than those illustrated in FIG. 2 and described herein. For example, user device 200 may include a camera, a video capturing component, and/or a flash for capturing images and/or video. Additionally, or alternatively, user device 200 may not include speakers 215 or display 225.

Housing 205 may include a structure to contain components of user device 200. For example, housing 205 may be formed from plastic, metal, or some other material. Housing 205 may support microphone 210, speakers 215, keypad 220, and display 225.

Microphone 210 may transduce a sound wave to a corresponding electrical signal. For example, a user may speak into microphone 210 during a telephone call or to execute a voice command. Speakers 215 may transduce an electrical signal to a corresponding sound wave. For example, a user may listen to music or listen to a calling party through speakers 215.

Keypad 220 may provide input to user device 200. Keypad 220 may include a standard telephone keypad, a QWERTY keypad, and/or some other type of keypad. Keypad 220 may also include one or more special purpose keys. In one implementation, each key of keypad 220 may be, for example, a pushbutton. A user may utilize keypad 220 for entering information, such as text, or for activating a special function.

Display 225 may output visual content and may operate as an input component (e.g., a touch screen). For example, display 225 may include a liquid crystal display (LCD), a plasma display panel (PDP), a field emission display (FED), a thin film transistor (TFT) display, or some other type of display technology. Display 225 may display, for example, text, images, and/or video to a user.

In one implementation, display 225 may include a touch-sensitive screen. Display 225 may correspond to a single-point input device (e.g., capable of sensing a single touch) or a multipoint input device (e.g., capable of sensing multiple touches that occur at the same time). Display 225 may implement, for example, a variety of sensing technologies, including but not limited to, capacitive sensing, surface acoustic wave sensing, resistive sensing, optical sensing, pressure sensing, infrared sensing, gesture sensing, etc. Display 225 may display various images (e.g., icons, a keypad, etc.) that may be selected by a user to access various applications and/or enter data. Display 225 may also include an auto-rotating function. Display 225 may serve as a viewfinder when user device 200 includes a camera or a video capturing component.

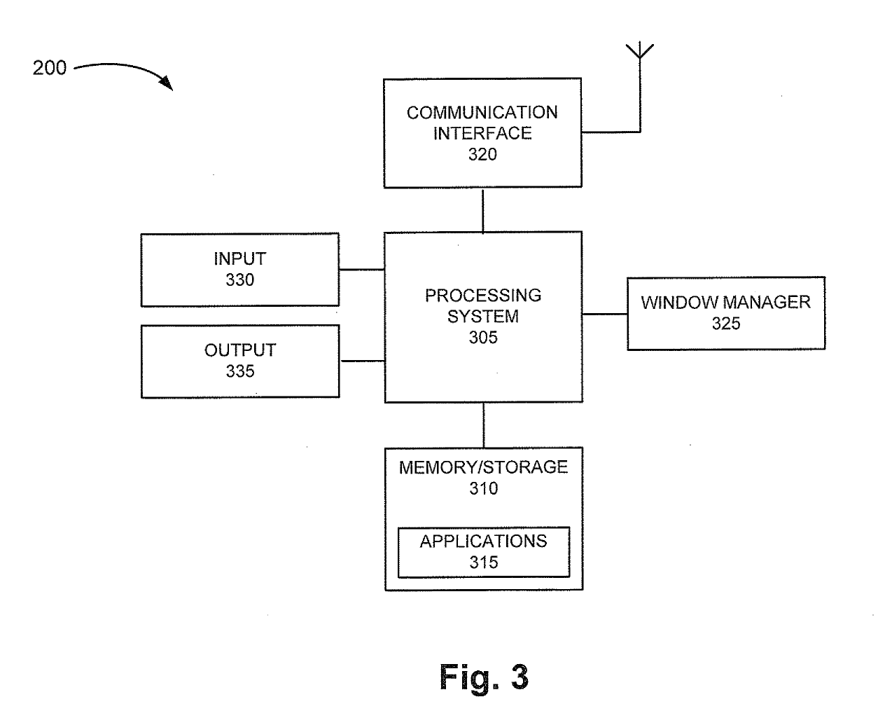

FIG. 3 is a diagram illustrating exemplary components of user device 200. As illustrated, user device 200 may include a processing system 305, a memory/storage 310 (e.g., containing applications 315), a communication interface 320, a window manager 325, an input 330, and an output 335. In other embodiments, user device 200 may include fewer, additional, and/or different components, or a different arrangement of components than those illustrated in FIG. 3 and described herein.

Processing system 305 may include one or multiple processors, microprocessors, data processors, co-processors, network processors, application specific integrated circuits (ASICs), controllers, programmable logic devices, chipsets, field programmable gate arrays (FPGAs), and/or some other component that may interpret and/or execute instructions and/or data. Processing system 305 may control the overall operation (or a portion thereof) of user device 200 based on an operating system and/or various applications.

Processing system 305 may access instructions from memory/storage 310, from other components of user device 200, and/or from a source external to user device 200 (e.g., a network or another device). Processing system 305 may provide for different operational modes associated with user device 200. Additionally, processing system 305 may operate in multiple operational modes simultaneously. For example, processing system 305 may operate in a camera mode, a music playing mode, a radio mode (e.g., an amplitude modulation/frequency modulation (AM/FM) mode), and/or a telephone mode.

Memory/storage 310 may include memory and/or secondary storage. For example, memory/storage 310 may include a random access memory (RAM), a dynamic random access memory (DRAM), a read only memory (ROM), a programmable read only memory (PROM), a flash memory, and/or some other type of memory. Memory/storage 310 may include a hard disk (e.g., a magnetic disk, an optical disk, a magneto-optic disk, a solid state disk, etc.) or some other type of computer-readable medium, along with a corresponding drive. The term “computer-readable medium,” as used herein, is intended to be broadly interpreted to include a memory, a secondary storage, a compact disc (CD), a digital versatile disc (DVD), or the like. For example, a computer-readable medium may be defined as a physical or logical memory device. A logical memory device may include memory space within a single physical memory device or distributed across multiple physical memory devices.

Memory/storage 310 may store data, application(s), and/or instructions related to the operation of user device 200. For example, memory/storage 310 may include a variety of applications 315, such as, an e-mail application, a telephone application, a camera application, a voice recognition application, a video application, a multi-media application, a music player application, a visual voicemail application, a contacts application, a data organizer application, a calendar application, an instant messaging application, a texting application, a web browsing application, a location-based application (e.g., a GPS-based application), a blogging application, and/or other types of applications (e.g., a word processing application, a spreadsheet application, etc.).

Communication interface 320 may permit user device 200 to communicate with other devices, networks, and/or systems. For example, communication interface 320 may include an Ethernet interface, a radio interface, a microwave interface, or some other type of wireless and/or wired interface. Communication interface 320 may include a transmitter and a receiver.

Window manager 325 may detect when a window is opened and closed, the size of the window, and/or the position of the window on display 225. Window manager 325 may detect when the size, position, and/or state (e.g., opened or closed) is being changed and how the window is being changed (e.g., in terms of size, position, state). Window manager 325 may determine a corresponding audio setting based on the identified window manipulation. Window manager 325 may process a corresponding audio signal before sending the signal to speakers 215. Window manager 325 may be implemented in hardware (e.g., processing system 305) or a combination of hardware and software (e.g., applications 315).

In one embodiment, window manager 325 may be implemented at a system level (e.g., in an operating system (OS) of user device 200). In another embodiment, window manager 325 may be implemented at an application level. That is, for example, application 315 (e.g., a telephony application, etc.) may provide for window manager 325 processes as a user-preference option. Window manager 325 will be described in greater detail below.

Input 330 may permit a user and/or another device to input information to user device 200. For example, input 330 may include a keyboard, microphone 210, keypad 220, display 225, a touchpad, a mouse, a button, a switch, an input port, voice recognition logic, fingerprint recognition logic, retinal scan logic, a web cam, and/or some other type of visual, auditory, tactile, etc., input component. Output 335 may permit user device 200 to output information to a user and/or another device. For example, output 335 may include speakers 215, display 225, one or more light emitting diodes (LEDs), an output port, a vibrator, and/or some other type of visual, auditory, tactile, etc., output component.

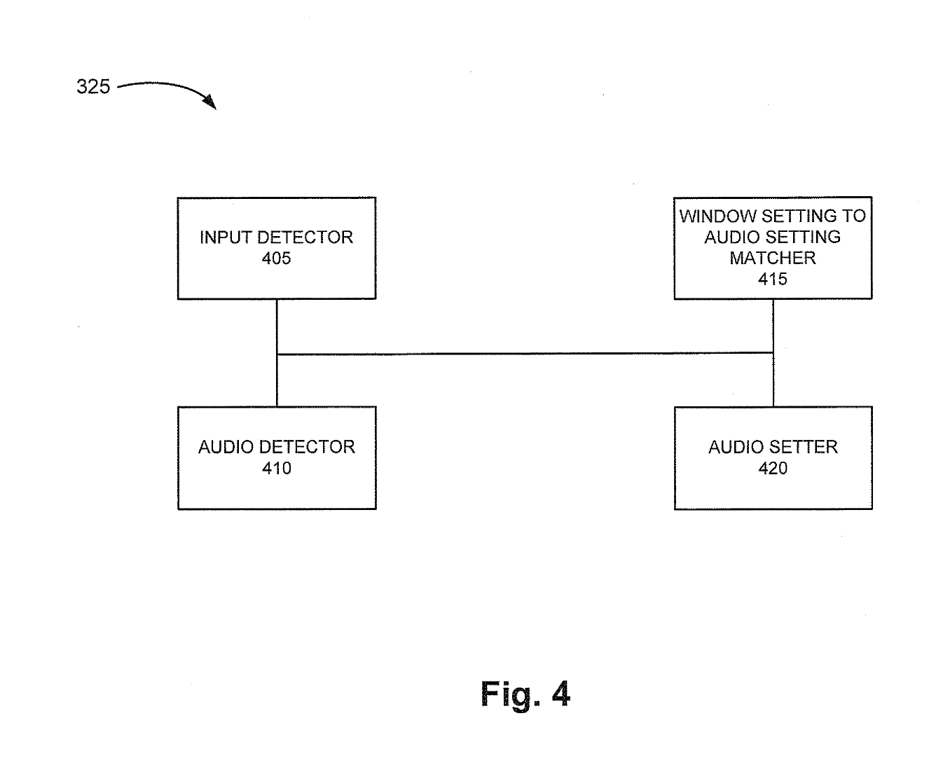

FIG. 4 is a diagram of exemplary functional components associated with window manager 325. As illustrated, window manager 325 may include an input detector 405, an audio detector 410, a window setting to audio setting matcher (WSASM) 415, and an audio setter 420. In other implementations, window manager 325 may include additional, fewer, or different components than those illustrated in FIG. 4 and described herein. Additionally, or alternatively, in other implementations, window manager 325 may include a different arrangement of components than the arrangement illustrated in FIG. 4 and described herein.

Input detector 405 may identify when a user input corresponds to a window manipulation event. The window manipulation event may include, for example, sizing of the window, positioning or moving of the window, minimizing the window, maximizing the window, opening the window, or layering the window with respect to another window. The user may utilize input 330 to perform the window manipulation. In instances when multiple windows are open, input detector 405 may identify the window manipulation with respect to other windows.

Audio detector 410 may identify when application 315, associated with the window, provides audio content. For example, some applications 315 typically may not provide audio content, such as, for example, an e-mail application, while other applications 315 typically may provide audio content, such as, for example, a media player. Additionally, some applications may or may not provide audio content. For example, a web browser may or may not provide audio content depending on the Web page accessed. Audio detector 410 may identify when application 315 provides audio content based on various factors, such as, for example, the type of application 315 or use or state information of application 315 (e.g., is application 315 currently playing audio content, is application 315 in a muted state, etc.).

WSASM 415 may match the window setting associated with the window manipulation event to a corresponding audio setting. As previously described, in one embodiment, a window setting and corresponding audio setting may be global, regardless of application. 315. For example, regardless of whether application 315 is a web browser or a media player, when the user positions the window to a left portion of display 225, the audio setting may provide that an audio signal associated with application 315 is panned to the left. In another embodiment, a window setting and corresponding audio setting may be application-specific. For example, when application 315 is the web browser, and the user positions the window to a left portion of display 225, the audio setting may provide that the audio signal associated with the web browser is not panned to the left, but provides a stereo narrowing. In contrast, when application 315 is the media player, and the user positions the window to a left portion of display 225, the audio setting may provide that the audio setting associated with the media player is panned to the left. In one implementation, the window setting and corresponding audio setting information may be stored in a database. The audio setting may be user-configurable.

Audio setter 420 may process the audio signal associated with application 315 so that the user perceives the audio signal, via, for example, speakers 215, in correspondence to the matched audio setting. Audio setter 420 may select appropriate values relating to phase and/or amplitude differences between the audio signals that may emanate from speakers 215 so that the user perceives the sound in correspondence to the audio setting. Audio setter 420 may utilize time delays in the transmission of the audio signals (e.g., the precedence effect or the Haas effect) so that the user perceives the audio signal in correspondence to the audio setting. By way of example, audio setter 420 may provide for various audio settings, such as, for example, stereo narrowing, stereo widening, increasing the volume, decreasing the volume, muting, panning effects, and phantom imaging. Audio setting 415 may output the processed audio signals to speakers 215.

As previously described, in one embodiment, window manager 325 may be implemented at a system level (e.g., in an operating system (OS) of user device 200). When window manager 325 is implemented at the system level, window manager 325 may include application programming interface(s) (API(s) to provide the audio control based on window settings. Window manager 325 may generate interrupt calls to various components (e.g., processing system 305, output 335, etc.) of user device 200 when performing one or more processes or operations described herein. Window manager 325 may operate as a background process.

In another embodiment, window manager 325 may be implemented at an application level. For example, a multi-media player may include user-preferences that provide audio control based on window settings. Application 315 may run according to these user preferences.

### Exemplary Process

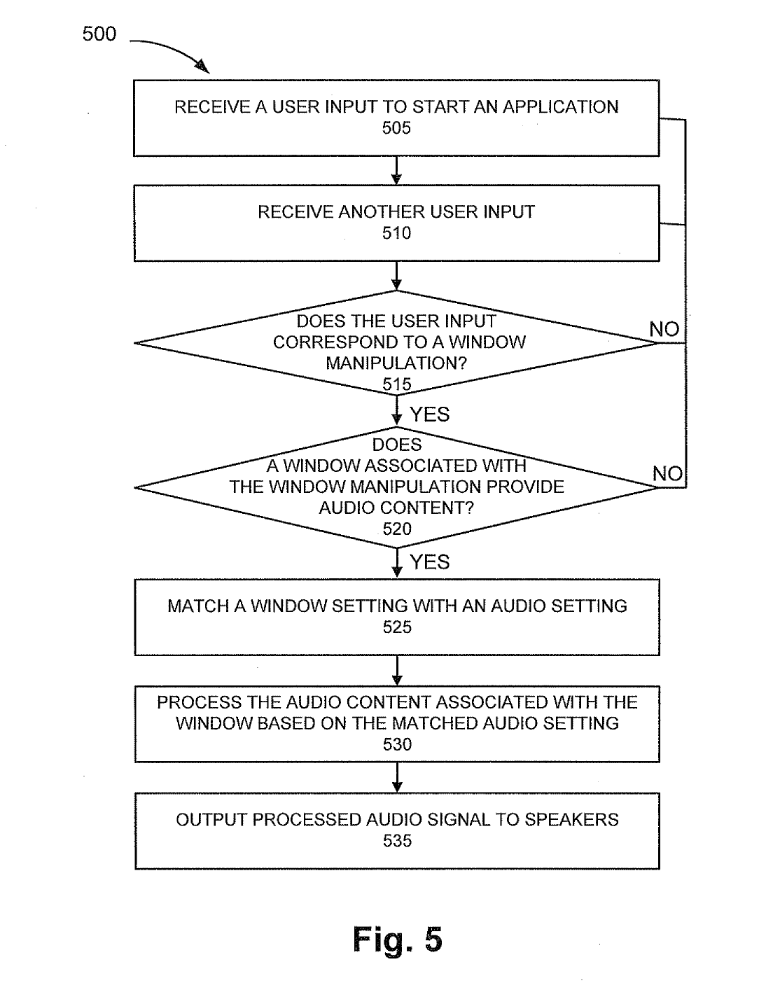

FIG. 5 is a flow diagram illustrating an exemplary process 500 for providing audio control based on window settings. Components of user device 200 described as performing a particular operation of process 500, may, in other implementations, be performed by other components of user device 200, or may be performed in combination with other components of user device 200.

Process 500 may begin with receiving a user input to start an application (block 505). User device 200 may receive an input to start application 315 from a user via input 330. In one embodiment, application 315 may reside on user device 200. A window associated with application 315 may be displayed on display 225. In one embodiment, initial window settings and corresponding initial auditory settings associated with application 315 may be obtained from a database (e.g., a registry file, a hidden data file, or some other type of system file depending on the platform in which user device 200 operates) that includes system setting information. The database may be loaded during boot-up of user device 200. For example, the database may be loaded during a Basic Input/Output System (BIOS) process or some other type of initialization process.

Another user input may be received (block 510). Input 330 may receive a user input. For example, the user input may correspond to a mouse click, a user's gesture on display 225, or some other type of user input associated with input 330.

A determination may be made whether the user input corresponds to a window manipulation (block 515). As previously described, input detector 405 may detect whether the user input corresponds to a window manipulation event. The window manipulation may include, for example, sizing of the window, positioning or moving of the window, minimizing the window, maximizing the window, opening the window, or layering the window with respect to another window. Input detector 405 may detect the user input based on input 330.

When it is determined that the user input does not correspond to a window manipulation (block 515—NO), process 500 may return to block 505 and/or block 510. On the other hand, when it is determined that the user input corresponds to a window manipulation (block 515—YES), it may be determined whether the window associated with the window manipulation provides audio content (block 520). As previously described, audio detector 410 may identify whether the window associated with the window manipulation provides audio content. In one implementation, audio detector 410 may identify whether the window associated with the window manipulation provides audio content based on the type of application 315 associated with window and/or the use or state of the window.

When it is determined that the window associated with the window manipulation does not provide audio content (block 520—NO), process 500 may return to block 505 or block 5 10. On the other hand, when it is determined that the window associated with the window manipulation provides audio content (block 520—YES), a window setting may be matched to an audio setting (block 525). For example, as previously described, WSASM 415 may perform a lookup based on the determined window manipulation. WSASM 415 may match the determined window manipulation (i.e., window setting) to a corresponding audio setting. In one implementation, the window setting and corresponding audio setting information may be stored in a database. In one implementation, the database may be user-configurable. Additionally, in one implementation, as previously described, the window setting/audio setting pair may be a global setting. In other implementations, the window setting/audio setting pair may be application-specific.

In one embodiment, when the window manipulation corresponds to increasing the size of the window, the audio setting may correspond to increasing the volume associated with the audio content. In another embodiment, when the window manipulation corresponds to decreasing the size of the window, the audio setting may correspond to decreasing the volume associated with the audio content. In still another embodiment, when the window manipulation corresponds to positioning of the window, the audio setting may correspond to a panning effect. For example, depending on the position of the window on display 225, the audio setting may include a panning to the left, to the right, or somewhere in-between. In yet another embodiment, when the window manipulation corresponds to positioning of the window, the audio setting may correspond to a stereo effect. For example, depending on the position of the window on display 225, the audio setting may include a stereo widening or a stereo narrowing. In another embodiment, when the window manipulation corresponds to a minimizing of the window, the audio setting may correspond to a muting or significant decrease in volume associated with the audio content. In still another embodiment, when the window manipulation corresponds to a maximizing of the window, the audio setting may correspond to a significant increase or maximizing of the volume associated with the audio content. Additionally, in some instances, the window manipulation may involve a combination of window manipulations (e.g., sizing and positioning of the window). In such instances, WSASM 415 may match multiple audio settings in correspondence to the multiple window settings.

The audio content associated with the window may be processed based on the matched audio setting (block 525). Audio setter 420 may the process the audio content based on the matched audio setting. For examples, as previously described, audio setter 420 may select appropriate values relating to phase, amplitude, and/or time delays associated with the audio content to provide various audio settings, such as, for example, stereo narrowing, stereo widening, increasing the volume, decreasing the volume, muting, panning effects, and phantom imaging.

The processed audio content may be output to speakers (block 530). Audio setter 420 may output the processed audio content associated with the window to speakers 215.

In some instances, the window manipulation may be relatively instantaneous. For example, the user input may correspond to a minimizing of the window or a layering of the window. In other instances, the window manipulation may have a longer time duration. For example, the user input may correspond to a sizing of the window or a positioning of the window. Depending on user device 110, the audio output of the audio content associated with the window may occur in real time.

Although FIG. 5 illustrates an exemplary process 500, in other implementations, process 500 may include fewer, different, and/or additional operations than those described. For example, in other embodiments, application 315 may reside on another device (not illustrated), for example, in a network setting. Additionally, or alternatively, application 315 may correspond to a web browser that accesses music or video content on another device.

While process 500 has been described with respect to a window associated with application 315, process 500 may involve multiple windows opened simultaneously. For example, when a window that may not provide audio content is layered over another window that provides audio content, the audio content associated with the window that provides audio content may be significantly decreased or muted. Conversely, when the window that may provide audio content is toggled back over the other window that does not provide audio content, the audio content may revert to its original audio settings. In other embodiments, the layering between a window providing audio content and a window not providing audio content may not cause an audio setting adjustment.

Additionally, while process 500 has been described with exemplary window setting/audio setting pairs, these window setting/audio setting pairs may be altered. For example, the position of the window on display 225 may be mapped to any of the audio settings described herein.

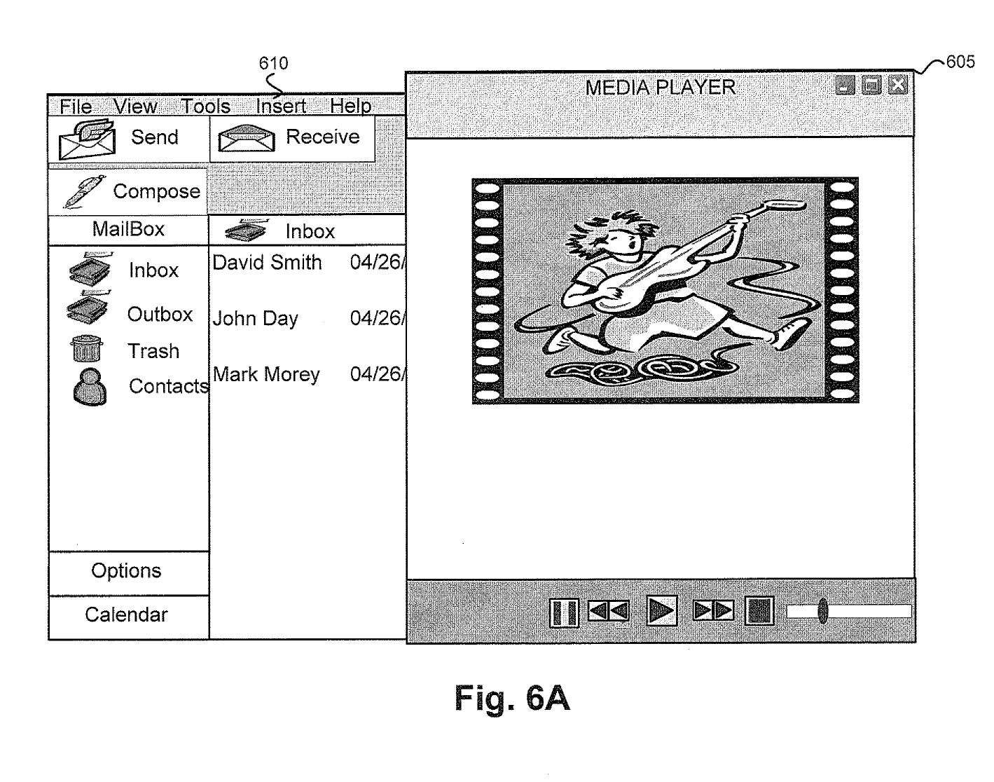

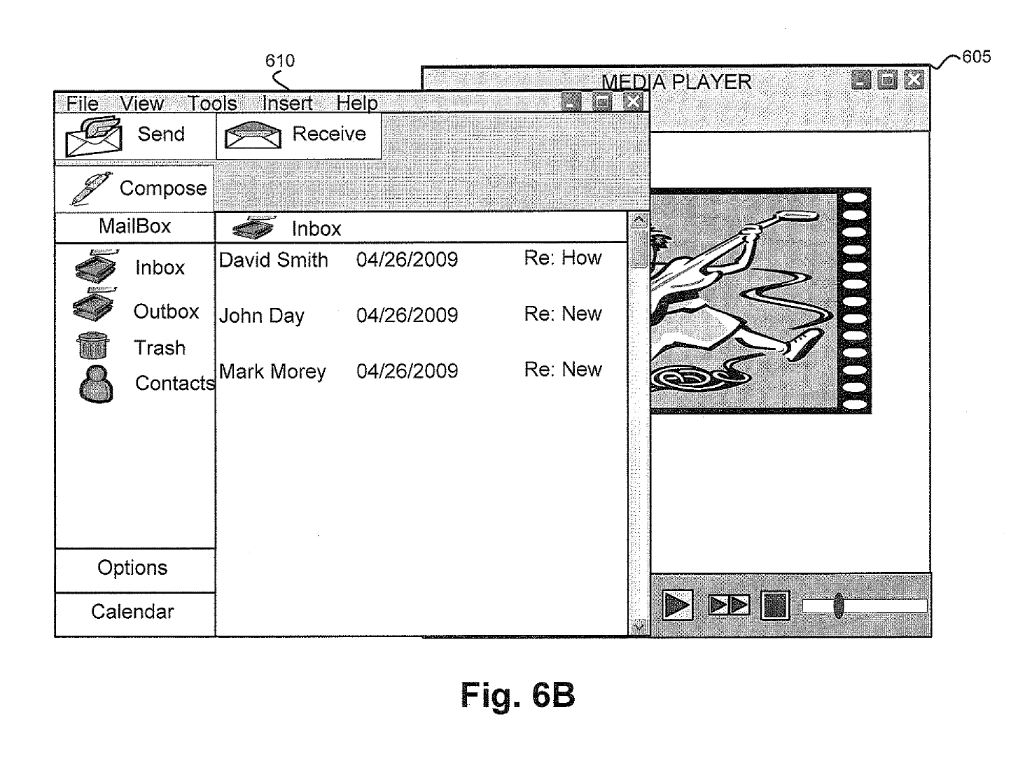

FIGS. 6A and 6B are diagrams illustrating an exemplary scenario related to controlling audio settings based on window settings. For example, as illustrated in FIG. 6A, assume that a window 605, associated with a media player, is providing multi-media content (e.g., a music video). Additionally, a window 610, associated with an e-mail application, is open. Thereafter, an important e-mail is received. Referring to FIG. 6B, when the important e-mail is received, a user device 200 may provide a visual and/or and auditory cue to the user. In response thereto, the user may reverse the layering of windows 605 and 610 so that window 610 is on top. Based on this window manipulation, the audio content associated with window 605 may be adjusted (e.g., the volume may be significantly decreased or muted).

In this case, the window manipulation of window 605 was indirect. That is, the layering of window 610 on top of window 605 may be a result of a user input to window 610. In one implementation, user device 200 (e.g., input detector 405) may identify whether a layering of window 605 exists with respect to another window (e.g., window 610), and whether the window manipulation corresponds to a re-layering of windows 605 and 610. Based on these determinations, audio setter 420 may adjust the volume associated with one of windows 605 or 610. In this example, window 605 may be muted or the volume associated with audio content of window 605 may be significantly decreased. In other examples, when window 605 and window 610 both provide audio content. In one embodiment, a user may selectively cursor between two or more windows without clicking on, for example, a mute button or adjusting the volume, with respect to one window, and selecting the other window to the forefront and/or un-muting or adjusting the volume with respect to the other window.

Other scenarios with respect to multiple windows may be envisioned. For example, consider a situation where a telephony application window may be hidden behind one or more other windows. Thereafter, user device 200 may receive an incoming communication (e.g., a telephone call). In this instance, the telephony application window may “pop up” or become layered on top of the one or more other windows. The audio associated with the telephony application may correspond to the position, size, etc. of the telephony application window. Thus, in this scenario, the invocation of the audio control based on window settings may be initiated by user device 200 or a calling party versus the user of user device 200.

In another scenario, consider a situation when the user is initially utilizing multiple displays (e.g., a primary display and a secondary display) and subsequently the user switches to using only one display. The window(s) on the secondary display may automatically appear or be moved to the primary display by user device 200. The audio associated with the window(s) may correspond to the position, size, etc. of the window(s) as the window(s) appear on the primary display. Thus, in this scenario, the invocation of the audio control based on window settings may be initiated by user device 200 (e.g., the OS of user device 200).

### Conclusion

The foregoing description of implementations provides illustration, but is not intended to be exhaustive or to limit the implementations to the precise form disclosed. Modifications and variations are possible in light of the above teachings or may be acquired from practice of the teachings.

It should be emphasized that the term “comprises” or “comprising” when used in the specification is taken to specify the presence of stated features, integers, steps, or components but does not preclude the presence or addition of one or more other features, integers, steps, components, or groups thereof.

In addition, while a series of blocks has been described with regard to the process illustrated in FIG. 5, the order of the blocks may be modified in other implementations. Further, non-dependent blocks may be performed in parallel. Further one or more blocks may be omitted.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” and “an” are intended to include one or more items. Where only one item is intended, the term “one” or similar language is used. Further, the phrase “based on” is intended to mean “based, at least in part, on” unless explicitly stated otherwise. As used herein, the term “and/or” includes any and all combinations of one or more of the associated list items.

What is claimed is:

1. A method, comprising:
displaying, by the user device, a window associated with an application;
providing, by the user device, audio content associated with the application;
receiving, by the user device, a user input;
determining, by the user device, whether the user input corresponds to a window manipulation of the window, where the window manipulation is other than a closing of the window;
determining, by the user device, an audio setting that corresponds to a window setting associated with the window manipulation, when it is determined that the user input corresponds to the window manipulation; and
outputting, by the user device, the audio content in correspondence to the audio setting.

2. The method of claim 1, further comprising:
determining, by the user device, whether the application provides audio content.

3. The method of claim 1, where the outputting comprises:
increasing, by the user device, a volume associated with the audio content, when the window manipulation corresponds to an increasing of a size of the window; and
decreasing, by the user device, the volume associated with the audio content, when the window manipulation corresponds to a decreasing of a size of the window.

4. The method of claim 3, where the volume corresponds to a ratio between the size of the window and an overall size of a display of the user device.

5. The method of claim 1, where the outputting comprises:
minimizing or muting, by the user device, a volume associated with the audio content, when the window manipulation corresponds to a minimizing of a size of the window; and
maximizing, by the user device, a volume associated with the audio content, when the window manipulation corresponds to a maximizing of a size of the window.

6. The method of claim 1, where the outputting comprises:
panning, by the user device, the audio content based on a position of the window on a display.

7. The method of claim 1, where the outputting comprises:
outputting, by the user device, a stereo narrowing associated with the audio content when the window manipulation corresponds to a positioning of the window to a first position on a display; and
outputting, by the user device, a stereo widening associated with the audio content when the window manipulation corresponds to a positioning of the window to a second position on the display, where the first position and the second position are different.

8. The method of claim 1, where the outputting comprises:
adjusting, by the user device, a volume associated with the audio content when the window manipulation corresponds to a layering adjustment of the window with respect to another window.

9. A user device to:
display a window associated with an application;
receive a user input;
determine whether the user input corresponds to a window manipulation of the window, where the window manipulation is other than a closing of the window;
select an audio setting that corresponds to a window setting associated with the window manipulation, when it is determined that the user input corresponds to the window manipulation of the window; and
output audio content associated with the application in correspondence to the audio setting that corresponds to the window setting.

10. The user device of claim 9, where the user device is further to:
determine whether the application provides audio content.

11. The user device of claim 9, where the user device includes a wireless telephone.

12. The user device of claim 9, where, when outputting, the user device is further to:
increase a volume associated with the audio content, when the window manipulation corresponds to an increase in a size of the window; and
decrease the volume associated with the audio content, when the window manipulation corresponds to a decrease in a size of the window.

13. The user device of claim 9, where, when outputting, the user device is further to:
minimize or mute a volume associated with the audio content, when the window manipulation corresponds to a minimizing of a size of the window; and
maximize a volume associated with the audio content, when the window manipulation corresponds to a maximizing of a size of the window.

14. The user device of claim 9, where, when outputting, the user device is further to:
pan the audio content in correspondence to a position of the window on a display.

15. The user device of claim 9, where, when determining whether the user input corresponds to the window manipulation, the user device is further to:
identify a position of the window on a display; and where, when outputting, the user device is further to:
provide a stereo narrowing based on the position of the window on the display.

16. The user device of claim 9, where, when determining whether the user input corresponds to the window manipulation, the user device is further to:
identify a position of the window on a display; and where, when outputting, the user device is further to:
provide a stereo widening based on the position of the window on the display.

17. The user device of claim 9, where, when determining whether the user input corresponds to the window manipulation, the user device is further to:
identify whether a layering of the window with respect to another window exists;
identify whether the window manipulation corresponds to a re-layering of the window with respect to the other window;
and where, when outputting, the user device is further to:
adjust a volume associated with the audio content of the window when it is determined that the window manipulation corresponds to the re-layering.

18. A computer-readable medium containing instructions executable by at least one processor, the computer-readable medium storing instructions for:
determining whether a user input corresponds to a window manipulation of a window associated with an application, where the window manipulation is other than a closing of the window;
selecting an audio setting that corresponds to a window setting associated with the window manipulation, when it is determined that the user input corresponds to the window manipulation of the window; and
outputting audio content associated with the application in correspondence to the audio setting that corresponds to the window manipulation.

19. The computer-readable medium of claim 18, where the computer-readable medium resides on a portable device.

20. The computer-readable medium of claim 18, where the instructions for outputting comprise:
adjusting one of a volume, a stereo effect, a panning, or a phantom imaging, of the audio content, in correspondence to the window manipulation.
